(19) United States
(12) Patent Application Publication
(10) Pub. No.: US 2023/0252473 A1
(43) Pub. Date: Aug. 10, 2023

(54) SECURE DATA EXCHANGE ORCHESTRATION

(71) Applicant: Treasury Intelligence Solutions GmbH, Heidelberg (DE)

(72) Inventor: Erol BOZAK, Rauenberg (DE)

(21) Appl. No.: 17/817,106

(22) Filed: Aug. 3, 2022

Related U.S. Application Data
(60) Provisional application No. 63/306,858, filed on Feb. 4, 2022.

(51) Int. Cl. G06Q 20/40; G06Q 20/38

(52) U.S. Cl. CPC G06Q 20/4014; G06Q 20/38215; G06Q 20/3827

(57) ABSTRACT

A method, a system, and a computer program product for executing a secure data exchange. A first information associated with a first computing device in the plurality of computing devices is authenticated by determining a validity of the first information. A verification certificate is generated and stored upon authenticating of the first information. An access identifier for accessing the verification certificate stored at a storage location is generated. An access to the verification certificate is provided upon a request to verify the first information from at least a second computing device in the plurality of computing devices, where the request includes the access identifier and the first information.

### CROSS-REFERENCE TO RELATED APPLICATIONS

The present application claims priority to U.S. Provisional Patent Application No. 63/306,858 filed Feb. 4, 2022, entitled “SECURE DATA EXCHANGE”. The entire contents of this application is incorporated herein by reference in its entirety.

### TECHNICAL FIELD

This disclosure relates generally to data processing and, in particular, to executing a secure data exchange process.

### BACKGROUND

Fraud is an intentional deception by one party to secure unfair and/or unlawful gain, and/or to deprive another party of their legal right. Document falsification (e.g., forgery), counterfeiting, theft of one's identity/personal information, etc. are some examples of fraud. Fraud may be committed through various means and media, e.g., mail, wire, phone, the Internet, etc. The international nature of the Internet and ease with which parties can hide their information, makes it difficult for parties to check identity and legitimacy of various data associated with online transactions that parties may be entering. Hence, there is a need for providing a secure online exchange of information and/or data.

### SUMMARY

In some implementations, the current subject matter relates to a computer implemented method for executing a secure data exchange orchestration. The method may include authenticating, using at least one processor, a first information associated with a first computing device in the plurality of computing devices, the authenticating including determining a validity of the first information, generating a verification certificate upon authenticating of the first information and storing the verification certificate at a storage location, generating an access identifier for accessing the verification certificate stored at the storage location, and providing an access to the verification certificate upon a request to verify the first information from at least a second computing device in the plurality of computing devices, the request including the access identifier and the first information.

In some implementations, the current subject matter can include one or more of the following optional features. The access identifier may include a universal resource locator. In some implementations, the second computing device, using the universal resource locator, may be configured to access the verification certificate. The verification certificate may be configured to be displayed on a website associated with the universal resource locator.

In some implementations, the verification certificate may be configured to include the authenticated first information (e.g., bank account information that has been authenticated and/or verified). The verification certificate may be configured to include a first hashed value of the authenticated first information. The first hashed value of the authenticated first information may be generated using a hashing algorithm identified in the verification certificate. The providing access may also include verification. Verification may include hashing the first information included in the received request using the hashing algorithm identified in the verification certificate and generating a second hash value, and comparing the first hash value and the second hash value. Upon the first hash value matching the second hash value, the first information included in the received request may be verified. Upon the first hash value not matching the second hash value, verification of the first information included in the received request may be denied.

In some exemplary implementations, the first information may be associated with a payment transaction and the first hashed value in the verification certificate may correspond to a hashed value of an authenticated account information for executing the payment transaction.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1a illustrates an exemplary handle, according to some implementations of the current subject matter;

FIG. 1B illustrates an exemplary bank account handle certificate, according to some implementations of the current subject matter;

FIG. 1c illustrates an exemplary chain of certificates, according to some implementations of the current subject matter;

FIG. 2a illustrates an exemplary system for performing a secure data exchange, according to some implementations of the current subject matter;

FIG. 2b illustrates an exemplary registration process, according to some implementations of the current subject matter;

FIG. 3a illustrates an exemplary system, according to some implementations of the current subject matter;

FIG. 3b illustrates an exemplary process for executing payment using system shown in FIG. 3a, according to some implementations of the current subject matter;

FIG. 3c illustrates exemplary payment requests, according to some implementations of the current subject matter;

FIG. 3d illustrates an exemplary transaction handle, according to some implementations of the current subject matter;

FIG. 3e illustrates an exemplary transaction context block, according to some implementations of the current subject matter;

FIG. 3f illustrates an exemplary alternate transaction handle, according to some implementations of the current subject matter;

FIG. 3g illustrates an exemplary transaction status handle chain, according to some implementations of the current subject matter;

FIG. 4 illustrates an exemplary system for performing a verification of data using a verification certificate, according to some implementations of the current subject matter;

FIG. 5 illustrates an exemplary verification process that may be executed by the system shown in FIG. 4, according to some implementations of the current subject matter;

FIG. 6 illustrates an exemplary website for verifying an account information that may be used by the system shown in FIG. 4, according to some implementations of the current subject matter;

FIG. 7 is an exemplary system, according to some implementations of the current subject matter; and

FIG. 8 is an exemplary method, according to some implementations of the current subject matter.

### DETAILED DESCRIPTION

To address these and potentially other deficiencies of currently available solutions, one or more implementations of the current subject matter relate to methods, systems, articles of manufacture, and the like that can, among other possible advantages, provide an ability to perform a secure data exchange.

In some implementations, the current subject matter relates to an ability to provide a secure data exchange by using a verification certificate that may be generated by an external entity (e.g., server, etc.). The system may be configured to be implemented in connection with payment systems, secure transaction systems, credential verification systems, and/or any other systems that may require and/or rely on a secure exchange of data and/or information among various entities (e.g., computing devices, servers, etc.).

Using the current subject matter, devices may be configured to execute a registration and verification certificate generation process during which information/data submitted by one entity (e.g., a computing device, a server, a computing system, etc.) may be ascertained and verified for the purposes of generating a verification certificate that may be used in any subsequent transactions and/or communications involving that entity and any other entity (e.g., another computing device, server, computing system, etc.). Each entity involved in the process may be independent registered and/or verified and/or have their own verification certificate. The information/data submitted by the entity may include new information/data, update to existing information/data, deletion of existing information/data, and/or any other information/data. Once the verification certificate has been generated, it may be accessed by other entities to verify identity of and/or any other information associated with the entity seeking to execute a transaction with such entities. The verification certificate may be accessed using a universal resource locator (URL) link and/or any other way. Once the verification certificate is accessed and information is confirmed, the entities may execute desired transactions (e.g., payment of invoices, wire transfers, accessing confidential information, sensitive or otherwise software installation, etc.).

In some exemplary, non-limiting implementations, the current subject matter may be configured to execute a registration and/or verification processes that may be used in connection with a global payment orchestration service (GPOS) that may allow for securely orchestrating a payment process between two or more parties using one or more bank account handles. A bank account handle may be configured to securely represent various data associated with a bank account information and may include one or more digital certificates and URLs that may be used to access such digital certificates. Further, the current subject matter may also provide for transactional and auditing processes that may involve use of a central immutable transaction context store that may allow entities to collaborate and share transaction context data in a secure way. In some exemplary, non-limiting implementations, a bank account handle may represent, for instance, a payer's and/or payee's bank account information/data (and/or, for example, a PayPal® account, a credit card, a cryptocurrency wallet, etc). Using the GPOS, the current subject matter may be configured to securely authenticate payer's and/or payee's bank account information/data and orchestrate the overall payment process on behalf of both entities.

Some of the advantages of the current subject matter may include an ability to securely manage exchange of information/data between various entities (e.g., exchange of sensitive banking information/data, confidential information/data, etc.). Using the current subject matter, all related information/data may be captured immutably in a single point of truth. Additionally, the current subject matter may provide a solution to one or more fraud scenarios, that may involve parties providing fraudulent information that another party may rely on, e.g., during an invoice fraud scenario. In the invoice fraud scenario, a fraudster notifies a payer company that supplier payment details have changed and provides alternative details to defraud the payer. The fraudster can claim to be from the company's genuine supplier, or even be posing as a member of the firm. Funds are often quickly transferred, so recovering money from fraudulent accounts can be extremely difficult. Using the current subject matter, the payee and payer may safely share their respective bank account handles thereby alleviating involve fraud scenario impossible. Moreover, using the techniques described herein, the current subject matter may allow to massively scale up/down the secure information/data exchange.

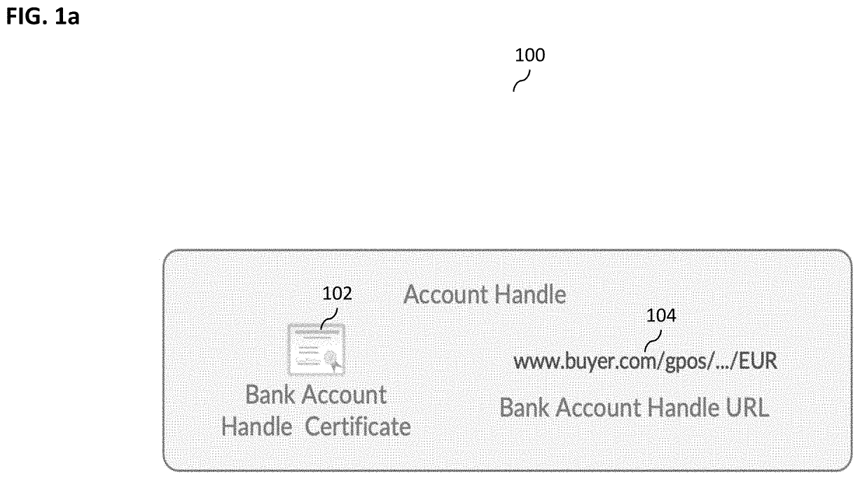

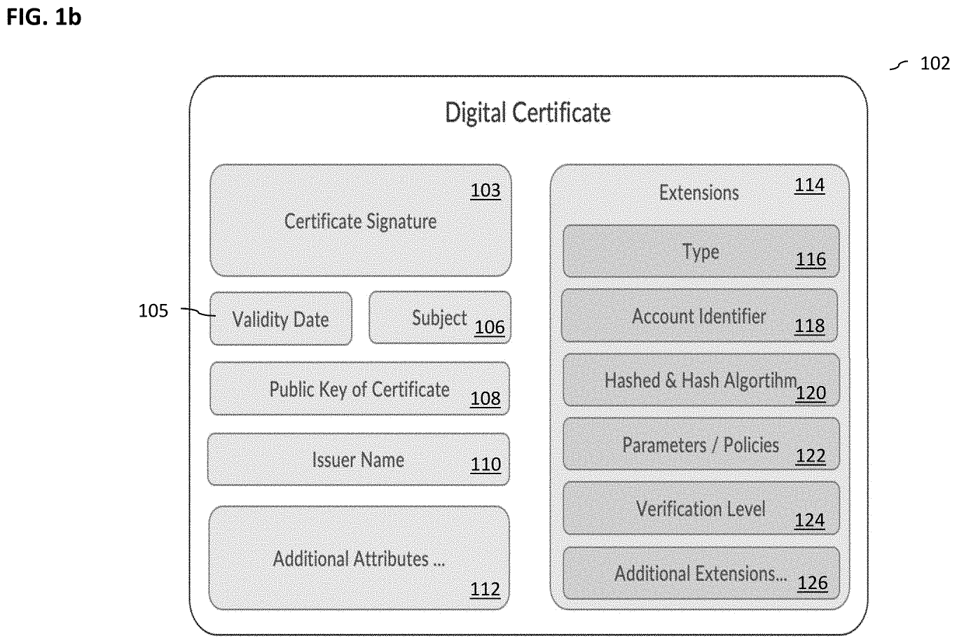

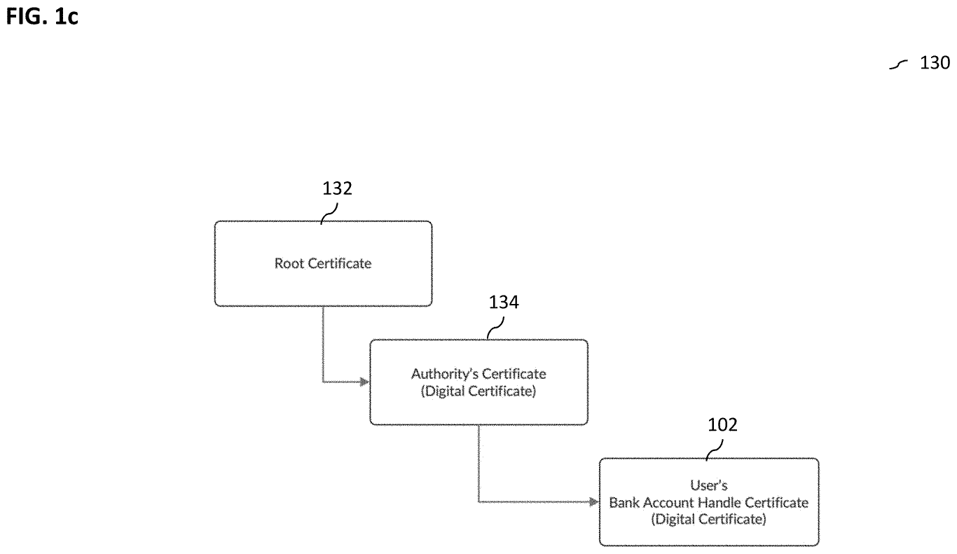

FIG. 1a illustrates an exemplary handle 100, according to some implementations of the current subject matter. The handle may be a data file, a data packet, a data structure, and/or any other type of structure that may be used for the purposes of securely storing and/or identifying information/data for the purposes of performing secure data exchange and/or any other purposes. The handle 100 may be stored in a storage location, a memory, a database, and/or at any other location. The handle 100 may be generated for a specific purpose (e.g., a transaction), and/or multiple purposes. It may exist temporarily (e.g., for a single transaction), and/or permanently.

For ease of illustration only, the following discussion will be presented in connection with use of a bank account handle 100 that may be used for the purposes of effectuating a secure payment transaction. However, as can be understood, the current subject matter is not limited to this implementation and may be applicable to any type of secure information/data exchange. Referring to FIG. 1a, the handle 100 may include a bank account handle certificate 102 and a bank account handle universal resource locator (URL) 104. The handle 100 may represent a payer's and payee's bank accounts information/data. Prior to using the GPOS process, the payer and the payee may each generate their own handles from their respective financial institutions and/or any other parties, e.g., banks, credit card companies, etc. (also referred to as an “authority” which includes a verification engine that may be used as part of the GPOS process) that may verify their identities. Once the handles are generated, the handles' certificates 102 may be published in one or more networks (e.g., Internet, intranet, etc.) using corresponding bank account handle URLs 104. Then, any payer may use the published handle of the payee to transfer funds to the payee's bank account for which the handle is issued.

To access the handle 100, the handle's URL 104 may be entered into, for example, a web browser, which then redirects to a GPOS web portal bank account verification HTML page via DNS redirection. In some exemplary implementations, the bank account handle URL 104 may be a fully qualified domain name (FQDN) and a bank path forming a single URL. The FQDN may belong to the account owner, and the bank path part of the GPOS system. The bank path may follow the Uniform Resource Locators RFC 1738 standard with path being a hierarchical representation for arriving at a bank account, based on most significant to lowest order. For example, the URLs 104 may be www.party1.com/gpos/europe/ . . . /euro, www.party1.com/gpos/africa/usd, www.party2.com/gpos/europe/sek. Account owner may have their FQDN as part of the bank handle as further proof of ownership and trust.

FIG. 1B illustrates an exemplary bank account handle certificate 102, according to some implementations of the current subject matter. The certificate 102 may include parts of a standard digital certificate as well as store additional information (e.g., in one or more extension fields). As shown in FIG. 1B, the certificate 102 may include one or more fields: a signature 103, a validity date 105, a subject 106, a public key of the certificate 108, an issuer name 110, one or more additional attributes 112, one or more extension fields 114, and/or any other fields. The extension fields 114 may include a type field 116, an account identifier field 118, a hashed and hashed algorithm field 120, a parameters/policies field 122, a verification level 124, and one or more additional extensions field(s) 126.

The signature field 103 may be configured to include a signature, which may be generated by the verification engine (or GPOS). The signature may be used to verify an authenticity of the certificate 102. In some implementations, the signature may be encrypted using a private key that may be associated with the verification engine. The signature of the certificate 102 may be an encrypted digest of the certificate content using a private key that only the signing party retains. The signing party may also have a public key that may be used for external verification of the signature. In this context, the signing party may be the verification engine that may have issued the certificate 102. In some exemplary implementations, the certificate 102 may be part of a chain of certificates where a leaf in the chain is the bank account handle certificate 102 which references the parent (issuer), i.e., the verification engine certificate. The verification engine's certificate may reference another parent certificate, etc. FIG. 1c illustrates an exemplary chain of certificates 130. The chain 130 may include a root certificate 132 having one or more child certificates 134, which may correspond to the verification engine's certificate(s), which, in turn, may have one or more child or leaf certificates that may correspond to one or more certificates 102.

Referring back to FIG. 1B, the validity date field 105 may include an indication of a validity time period associated with the certificate 102. For example, the certificate 102, as generated by the verification engine, may be valid for a period of three months from the date of issuance of the certificate by the verification engine. Upon expiration of the validity time period, the certificate 102 may be deemed expired and may no longer be used to verify one or more parties and/or any transactions that may be associated with the generated certificate 102. A new verification certificate 102 may need to be generated by the verification engine. Such new verification certificate 102 may be generated automatically and/or manually by the verification engine (subject to appropriate verification), upon receiving a request from the entity(ies), and/or using any other methods.

The subject field 106 may include a subject of the certificate. For example, the subject may identify a specific entity (and/or a computing device, a server, an entity associated therewith, etc.), a specific transaction, a specific account information, a purpose of the certificate, and/or any other information.

The public key of certificate field 108 may be configured to include a public key. The public key may be used for the purposes of verifying the issuer of the certificate and/or for any other purpose. Data that has been encrypted with a public key may be decrypted only with the corresponding private key. The certificate may verify that an entity (e.g., issuing the certificate) is the owner of a particular public key.

The issuer name field 110 may be configured to include a name of the entity issuing the certificate. For example, the verification engine may be included in the field 110.

The additional attributes field 112 may include further attributes that may be associated with the certificate, such as, for example, specific device (and/or a computing device, a server, an entity associated therewith, etc.), a specific transaction, a specific account information, a purpose of the certificate, and/or any other information.

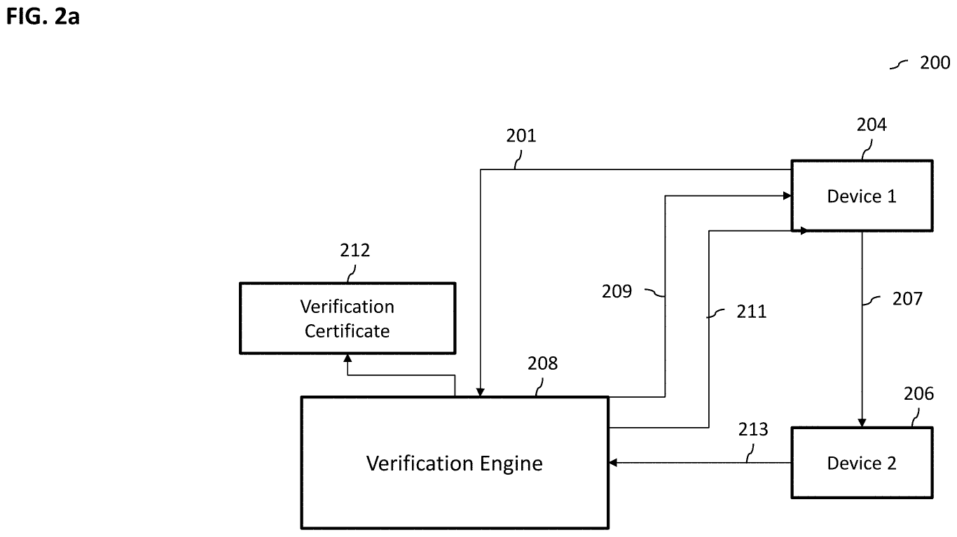

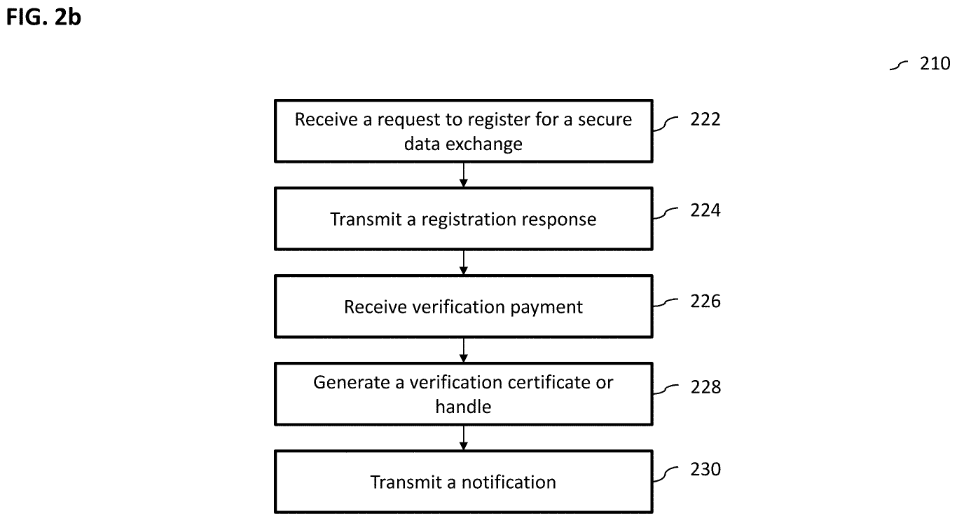

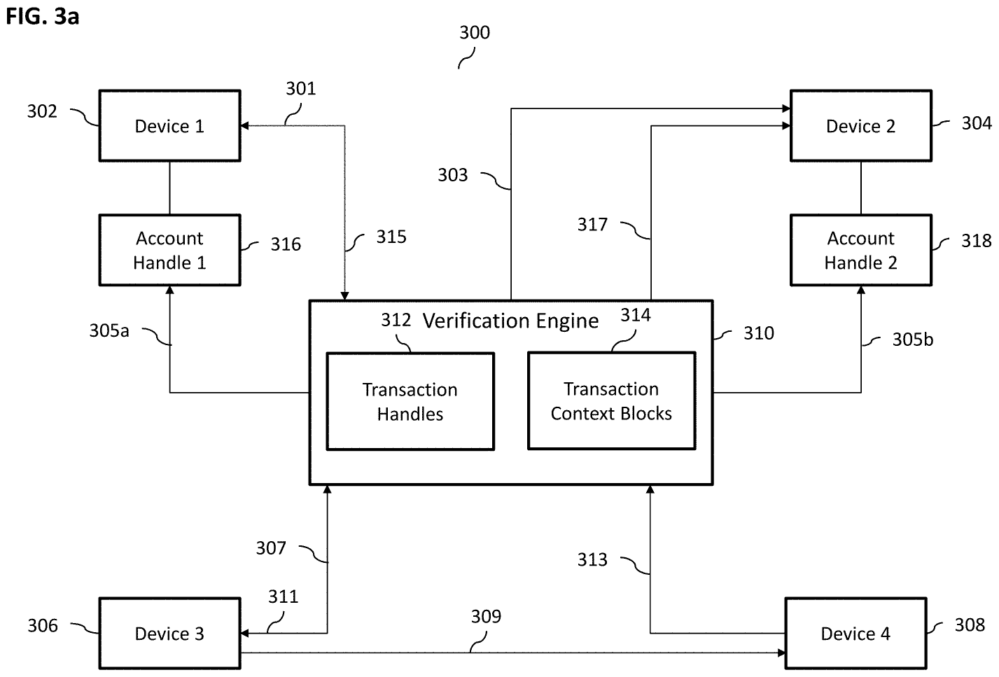

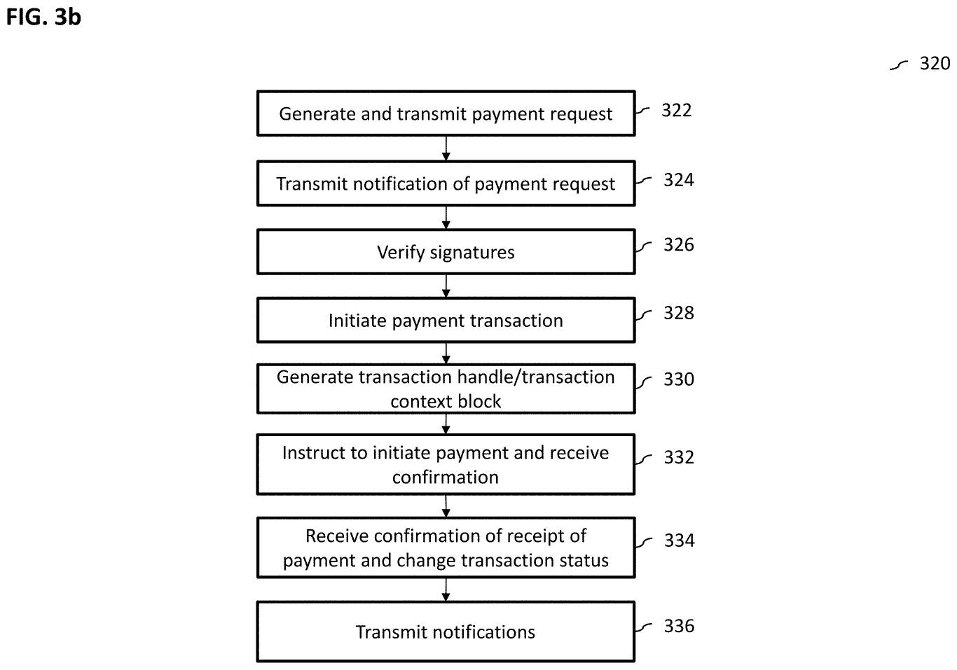

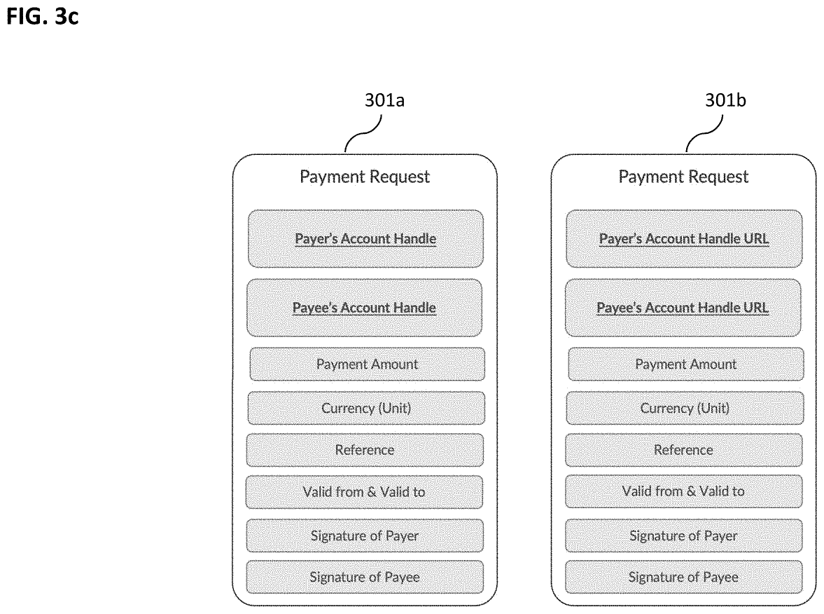

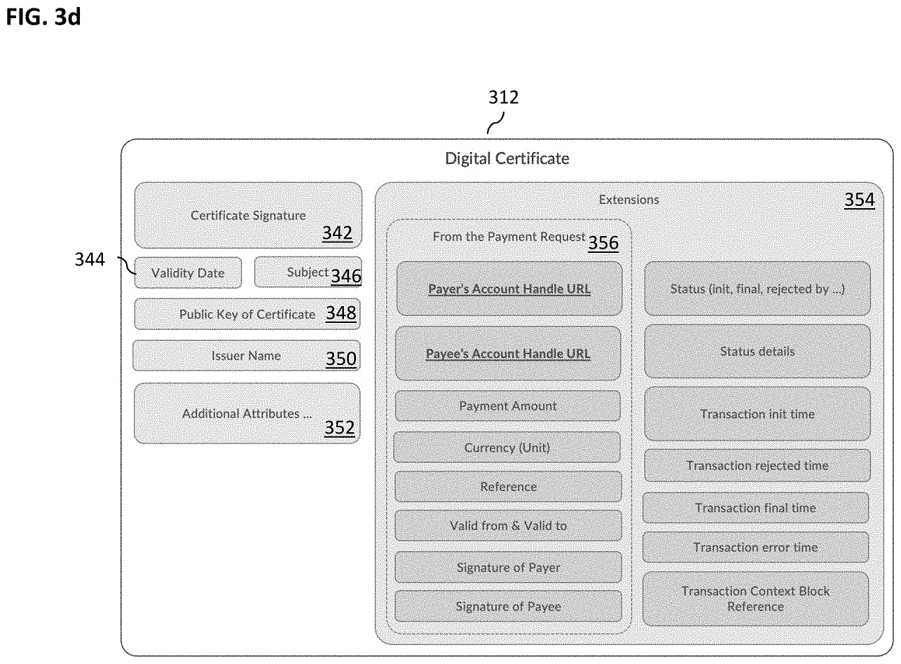

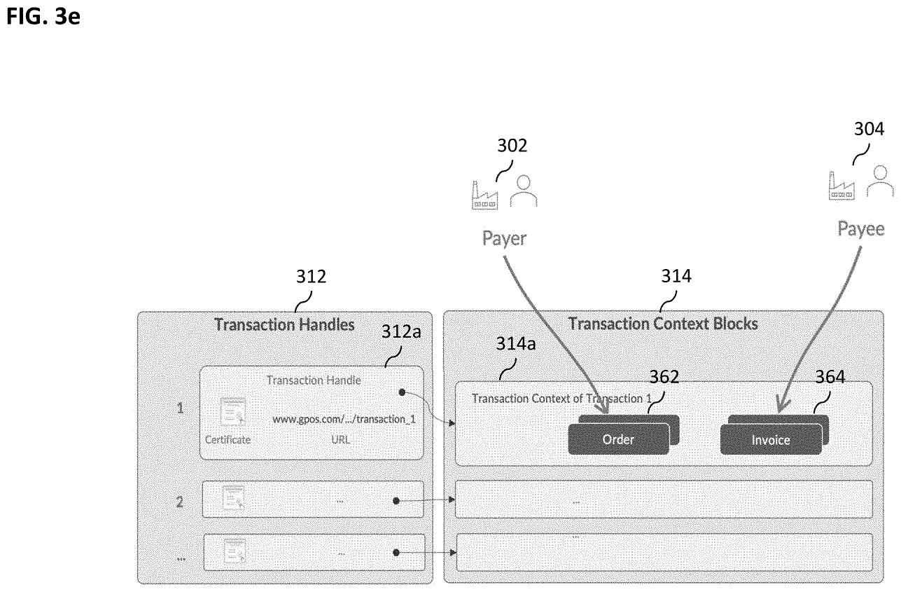

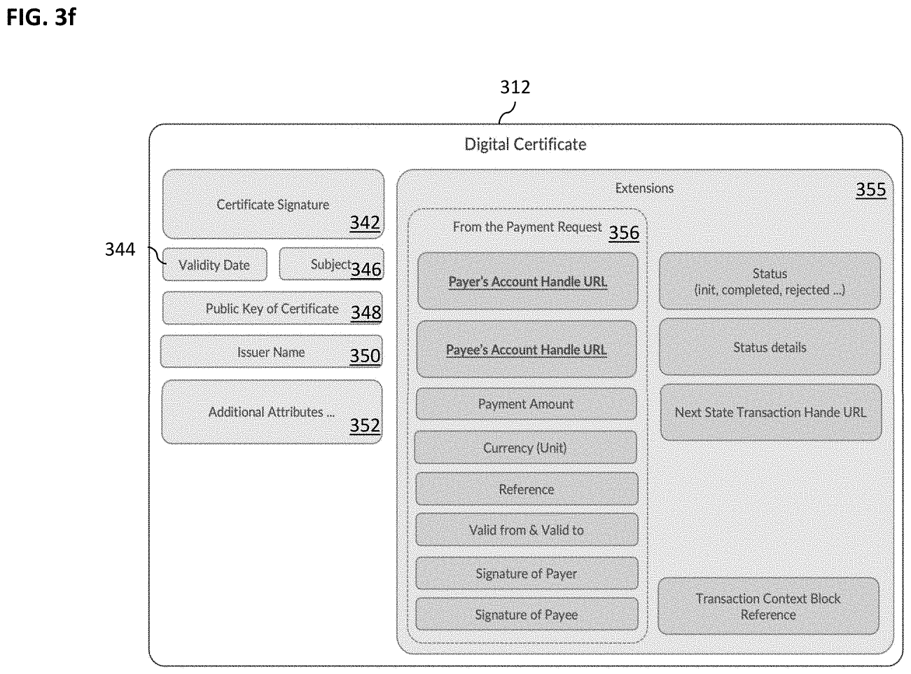

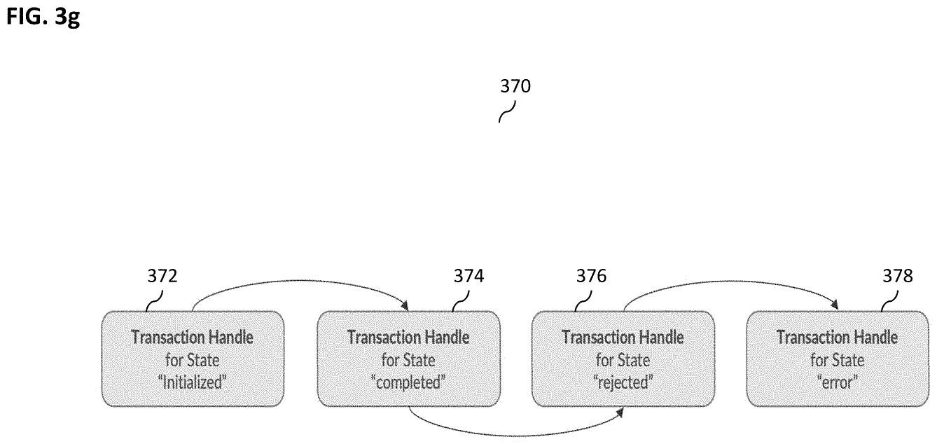

In some implementations, the certificate 102 may be configured to include one or more extensions that may be identified in the extensions field 114. For example, in the financial transaction (e.g., invoice payment) above, the field 114 may include a payee's payment service type extension 116. This field may identify a preferred payment method of the payee (e.g., device 204 shown in FIG. 2a, device 304 shown in FIG. 3a), e.g., a bank credit transfer, a credit card payment, a third party payment service transaction, etc.

Further, the extension field(s) 114 may include a service and/or an account identifier extension field 118. The service/account identifier may correspond to a service/account through which the payee may be paid, e.g., in case of the bank credit transfer, the service identifier may identify an account number of the creditor.

Additionally, one or more security fields 120 (“hashed and hashed algorithm”) may also be included in the extension field(s) 114. For example, the field(s) 120 may include a field indicating whether the account/service identifier is hashed or not. Another field 120 may include a field identifying a hashing algorithm (e.g., checksum, MD5, etc.), which may need to be executed in the event the service identifier is hashed. The current subject matter may be configured to store a hash value of a payee's account number (instead of storing the account number) in the certificate so that the actual account information is kept secret. Thus, to perform the payment transaction, the payer may be configured to hash the account number that it receives from the payee using the hashing algorithm identified in the certificate and then compare the resulting hash with the hash contained in the certificate (i.e., in one of the extension fields 114).

The parameters/policies field 122 may define additional parameters and policies which may influence the payment process, such as, for example, a payee may define that the payee only wants to receive payments from certain countries, and/or payee accepts payments only if they are approved by the payee. In some exemplary implementations, the verification engine (e.g., the account holding bank) may define through which interface and/or channel it wants to retrieve the payment request.

The verification level field 124 may include information about various verification levels that may be determined in accordance with one or more levels of confidence the verification should be performed (e.g., confidence levels A, B, C etc.). For example, using one level (e.g., level A), the payee pays to the bank account of the verification engine through which the match between name and bank account number may be verified (as discussed below in connection with the registration process).

The certificate 102 and its extension fields 114 may be further expanded to include addition extension fields 126. Such fields may be customized for a particular scenario, transaction, etc.

FIG. 2a illustrates an exemplary system 200 for performing a secure data exchange, according to some implementations of the current subject matter. The system 200 may include a verification engine 208 that may be configured to generate one or more verification certificates 212 (similar to certificate 102 shown in FIG. 1a). The system 200 may be configured to operate in one or more cloud computing environments, clustered computing environments, and/or any other computing environments. It may include one or more users, entities, computing devices, servers, applications, etc. 204, 206 (e.g., device 1 204, device 2 206, etc.) that may be configured to access and/or rely on the engine 208 to ensure secure exchange of data among devices 204-206. The engine 208 may include one or more computing elements and/or components, which may, for example, as discussed below, include one or more processors, one or more servers, one or more computing engines, one or more memory and/or storage locations, one or more databases, etc. A computing component may refer to a piece of software code that may be configured to perform a particular function, a piece and/or a set of data (e.g., data unique to a particular user and/or data available to a plurality of users) and/or verification data used to generate, modify, etc. one or more verification certificates for a particular device 204 and/or a set of users. For example, in a payment transaction, a supplier may be configured to send an invoice to and/or a change of a payment account a buyer and request payment/change of account. In order to verify an authenticity of the transmitted invoice/account change, each of the buyer and supplier may have their own verification certificates and submit to a verification process (e.g., using verification engine 208) to ensure that the requested invoice/changed account/etc. are authentic. The verification engine 208 may be configured to verify the parties using their verification certificates and allow the transaction to proceed, if so warranted.

The engine 208 may include a processor, a memory, and/or any combination of hardware/software, and may be configured to generate a verification certificate for the device 204 so that such certificate may be used to verify it in a particular transaction. The engine 208 may include one or more artificial intelligence and/or learning capabilities that may rely on and/or use various data, e.g., data related to and/or identifying one or more on-demand instances that have been previously requested by and/or generated for the device 204.

The elements of the system 200 may be communicatively coupled using one or more communications networks. The communications networks can include at least one of the following: a wired network, a wireless network, a metropolitan area network (“MAN”), a local area network (“LAN”), a wide area network (“WAN”), a virtual local area network (“VLAN”), an internet, an extranet, an intranet, and/or any other type of network and/or any combination thereof.

The elements of the system 200 may include any combination of hardware and/or software. In some implementations, the elements may be disposed on one or more computing devices, such as, server(s), database(s), personal computer(s), laptop(s), cellular telephone(s), smartphone(s), tablet computer(s), and/or any other computing devices and/or any combination thereof. In some implementations, the elements may be disposed on a single computing device and/or can be part of a single communications network. Alternatively, the elements may be separately located from one another.

Referring to the supplier payment/account change example above, in some exemplary, non-limiting implementations, the system 200, and specifically, the verification engine 208, may be configured to generate a universal resource locator (URL) (e.g., www.abccompany.com/account) that may be combined with the digital certificate into the verification certificate 212 (or a handle 100 as shown in FIG. 1). Using the generated URL, the device's 204 information/data (e.g. bank account) may be resolved in a secure manner. The generated URL may be configured to represent a destination that a client (e.g., device 204 or any other device) may be configured to receive a detailed information about how another device, e.g., a payee, may be require and/or wish to receive funds, which may be referred as a resolution. The system 200 may be configured to execute the resolution by reading the verification certificate 212 associated with the website (e.g., www.abccompany.com/account) to which the generated URL may be configured to point and retrieve, for instance, bank account information included in the generated certificate 212 (which may also be referred to as an account information certificate). As stated above, the verification certificate 212 may be generated by the verification engine 208, which may be a trusted device and/or a source (e.g., an authority, a bank). The information included in the verification certificate 212 is trustworthy, and may include, for example, payee's name, address, bank account information, and/or any other information. The information may be verifiable using one or more third party sources.

In some implementations, prior to verifying a particular device (and/or a user), the system 200 may be configured execute a registration process 210, as shown in FIG. 2b. During the registration process, a verification certificate 212 may be generated by the verification engine 208 of the system 200. Referring to FIGS. 2a-b, the process 210 may be initiated, at 222, by the device 204, which may be configured to transmit to the verification engine 208 a request 201 to perform a registration for the purposes of executing a secure data exchange. Such request may, for example, include a generation of a new account, a new source, a change (e.g., add, modify, delete) certain information, a registration of the device for the purposes of the secure exchange, etc. that may be associated with the device 204. The verification engine 208 may be configured to transmit to the device 204 a registration response 209.

In a payments scenario, a payee and/or a payer (e.g., device 204) may be configured to execute registration processing using a web site of the authority (e.g., the verification engine 208). During the registration, the device 204 may transmit all necessary information to authenticate the device and the bank account information for which the bank account handle (e.g., handle 100 as shown in FIG. 1) is to be created. The exemplary information may include one or more of the following: name, address, phone number, business related information, bank account details such as bank name, BIC, IBAN, etc. A desired URL for the verification certificate may also be provided. Alternatively or in addition to, the verification engine 208 may generate a URL. Further, during the registration process, the device 204 may be configured to define how it wants to be verified and define levels of verification (e.g., level A, B, C, etc.).

For example (level A, see below), the payee may pay to a bank account of the authority (e.g., verification engine 208) through which a match between the name of the payee and the bank account number may be verified. In this case, the payee may receive a registration reference number during the registration process that may be used in payment details (e.g., remittance information of the transaction). Alternatively or in addition to, the payee may request an extended verification by the authority (e.g., verification engine 208). In this case the payee may be required to transmit additional evidence to the authority (e.g., commercial register extract, etc.). As can be understood, different levels of verification may exist and/or may be requested.

Referring back to FIG. 2, the request to register 201 may include one or more of the following exemplary registration information: name and email, desired verification level (A, B, C etc.) and any additional information depending on the selected verification level, bank account handle information, account information, type and account identifier, hashed or not hashed, a desired bank account handle URL (e.g., either standard (defined by the verification engine 208) or custom (defined by a user of the device 204), where in the case of a custom URL, the user may submit URL's text, and parameters/policies. These may be incorporated by the verification engine 208 into the extensions 114 of the certificate 102, as shown in FIG. 1B.

Upon receipt of the above information, the verification engine 208 may be configured to respond, at 224, to the device 204 with the registration response 209. The registration response 209 may include instructions to complete the registration of the device 204 with verification engine 208. The instructions may be verification level specific. For example, for level A verification, one or more of the following information may be transmitted to the device 204 as part of the registration response 209: a registration reference number, payment instructions of the verification engine 208 for transmittal of a verification payment, a timestamp, a verification timeframe (e.g., within what timeframe the device 204 has to complete registration with the verification engine 208), and/or any other information.

In some implementations, a level of verification may be dependent on various local (e.g., geographic, industry, etc.) verification requirements, regulations (e.g., banking regulations, government regulations, etc.), standards, etc. Further, the device 204 may also be configured to define one or more confidence levels for the verification. Alternatively, confidence levels may be assigned based on at least one of the following: specific information/data that the device 204 may seek to verify, nature of the transaction between device 204 and/or another device, and/or any other factors. Using the confidence levels, the verification engine 208 may be configured to determine whether there is a match between one or more information/data provided by the device 204 and information/data that may be independently available to the verification engine 208 (e.g., by accessing a third party database (e.g., government database, banking database, etc.). In some implementations, to attain a certain confidence level, the verification engine 208 may be configured to request the device 204 to provide various information/data in addition to the information/data contained in the response 209.

At 226, the verification engine 208 may be configured to receive a verification payment from the device 204 and more specifically, from device 2 206, which may represent a bank associated with the user of the device 204. In particular, the device 204, upon receiving registration response 209, may transmit instructions 207 to the device 206 to initiate a payment 213 (e.g., a fund transfer from a bank account associated with the user of the device 204) to the verification engine 208 using bank account information received in the registration response 209. The verification engine 208 may be configured to provide specific instructions for transmittal of payment to it. Such instructions may be included in the registration response 209. To identify the transmitted payment, the registration reference number may be transmitted together with the payment.

At 228, upon the verification engine 208 receiving payment from the device 206, the verification engine 208 may be configured to retrieve the registration reference number from the data associated with the received payment and/or any other data (e.g., user name, account information, etc.) and compare it with the stored information. If there is a match, the verification engine 208 may be configured to generate a handle (e.g., a handle 100 as shown in FIG. 1a) using the corresponding bank account handle certificate and the bank account handle URL. In some exemplary implementations, an extended verification may be executed by the verification engine 208 (e.g., as per requests defined during the registration process). This may include performing further checking/verifying of information by the verification engine 208. Upon confirming the registration reference number and/or any other information to the request degree of confidence, the verification engine 208 may be configured to proceed with execution of the generation of verification certificate or handle 212 (e.g., handle 100 shown in FIG. 1a).

At 230, once the verification certificate 212 has been generated by the verification engine 208, the verification engine 208 may be configured to generate and transmit a notification 211 to the device 204. The notification 211 may indicate that the registration process (e.g., process 210) has been completed and the data/information provided by the device 204 may now been used for execution of transactions by/between device 204 and/or any other devices. The notification 211 may include a URL and/or any other identifier that may be used to access the generated verification certificate 212. The generated verification certificate 212 may be stored by the verification engine 208, a third party server, a cloud storage location, a database, and/or any other accessible storage location. For example, in a payment transaction example above, the device 204 may be configured to transmit a copy of the URL and/or any other identified provided in the notification 211 to verification engine 208 (and/or request verification engine 208 access it) prior transmission of any invoices for payment to that device. Then, the verification engine 208 (e.g., upon receipt of an invoice from the device 204) may use the URL/other identifier of the verification certificate 212 to access the generated verification certificate 212, read the certificate 212, ascertain the bank account information and compare it to the bank account information that it has previously received to verify legitimacy of the transmitted invoice and/or any associated account information, such as, for example, for the purposes of executing payment to device 204. As can be understood, any information may be verified for any purposes using this procedure. In some implementations, users of devices may receive additional documents, such as, for instance, a printable certificate in a form of a PDF document with all the related registration information. This may be used by the user to prove the authenticity of its bank account information manually when handing out invoices.

FIG. 3a illustrates an exemplary system 300, according to some implementations of the current subject matter. The system 300 may be used by a payer and a payee to execute a payment from the payer to the payee. While the following discussion will be presented in the context of a payment system, as can be understood, the system 300 may be used for any type of exchange of data in a secure manner. The system 300 may include a device 1 302 (e.g., a payer), a device 2 304 (a payee), a device 3 306 (e.g., payer's financial institution, such as, a bank), a device 4 308 (e.g., payee's financial institution, e.g., a bank), and a verification engine 310. The verification engine 310 may be similar to the verification engine 208 shown in FIG. 2a.

The elements of the system 300 may be communicatively coupled using one or more communications networks. The communications networks can include at least one of the following: a wired network, a wireless network, a metropolitan area network (“MAN”), a local area network (“LAN”), a wide area network (“WAN”), a virtual local area network (“VLAN”), an internet, an extranet, an intranet, and/or any other type of network and/or any combination thereof.

The elements of the system 300 may include any combination of hardware and/or software. In some implementations, the elements may be disposed on one or more computing devices, such as, server(s), database(s), personal computer(s), laptop(s), cellular telephone(s), smartphone(s), tablet computer(s), and/or any other computing devices and/or any combination thereof. In some implementations, the elements may be disposed on a single computing device and/or can be part of a single communications network. Alternatively, the elements may be separately located from one another.

As shown in FIG. 3a, each device 302 and 304 may be associated and/or include their own respective verification certificates or handles (e.g., similar to handle 100), i.e., device 302 may be associated with a handle 316 and device 304 may be associated with a handle 318. The handles 316, 318 may have been generated using system 200 shown in FIG. 2a (and corresponding process 210 shown in FIG. 2b). The handles can be used to prove ownership of accounts associated with particular entities, and/or link accounts with entities, and/or verify respective identities of the devices 302, 304 and/or respective entities associated therewith. In some exemplary implementations, both devices 302, 304 may be subscribed and/or communicatively coupled to the verification engine 310 for the purposes of executing payments. The subscriptions may be specific to particular financial institutions, where the verification engine 310 may be configured to provide one or more application programming interfaces (APIs) to interact with devices' financial institutions (e.g., devices 306, 308).

FIG. 3b illustrates an exemplary process 320 for executing payment using system 300 shown in FIG. 3a, according to some implementations of the current subject matter. To execute the process 320, both devices 302 and 304 (e.g., a payer and a payee) may be registered with the verification engine 310. The devices 302 and 304 may register with the verification engine using respective device 3 306 and device 4 308 (e.g., payer's financial institution and payee's financial institution). Upon registration, devices 302 and 304 may be issued their respective handles or verification certificates 316 and 318. At 322, a payment request 301 may be generated by the device 302 (e.g., payer (used interchangeably herein)), for instance, to pay an invoice issued by the device 304 (e.g., payee (used interchangeably herein)). The payment request may be transmitted to the verification engine 310.

In some exemplary implementations, the payment request 301 may include at least one of the following attributes: (1) payer's bank account handle or bank account handle URL (e.g., account handle 1 316), (2) payee's bank account handle or bank account handle URL (e.g., account handle 2 318), (3) payment amount, (4) currency (and/or a unit of value exchange), (5) a reference, (6) a “valid from” date, (7) a “valid to” date, (8) a signature of the payer, (9) a signature of the payee (which may be optional), and/or any other information. There are two options to construct the request 301, as shown in FIG. 3c. One alternative is a request 301a that may be generated using the payer's and/or payee's bank account handles 316, 318. Another alternative is a request 301b that may be generated using the respective bank account handle URLs. The signature may include an encrypted digest of the above attributes (1)-(7) in the generated request. The signature may be encrypted using a private key of the payer's bank account handle certificate. The signature may be used to prove that the payer/device 302 has generated this request, where the payer owns the private key of the payer's bank account handle certificate. Optionally, the payee/device 304 may sign with payee's private key. In this case the signature of the payee may correspond to the digest of the attributes (1)-(8) with the private key of payee's bank account handle certificate. This optional signature may be used to show that the payee/device 304 accepted the transfer of the amount to payee's account prior to instructing the transfer by the payer. The attributes “valid from” and “valid to” may define a timeframe during which the generated payment request may be valid. In some exemplary, non-limiting implementations, the signature of the payee may be required, for instance, if the policy of the bank account handle 318 of the payee defines that this is required. This information may be stored in the parameters/policies extension field 122 of the certificate 102 (as shown in FIG. 1B).

Referring back to FIGS. 3a-b, once the payer/device 302 transmitted the generated request 301 to the verification engine 310, the engine 310 may, optionally, transmit to the payee/device 304 a notification 303, at 324, to approve the payment request by requesting the payee/device 304 to sign the payment request. In this case, the payer/device 302 may sign the payment request 301 using payer's private key (e.g., the payee may access a website using a URL associated with the request 301 provided by the verification engine 310 to sign the payment request 301). The verification engine 310 may wait to continue the payment transaction until the payee/device 304 signed the request 301.

After the request is signed/approved, the verification engine 310 may verify the request, at 326, by transmitting a verification requests 305a, 305b, verifying the signatures contained in the handles 316, 318 of payer/device 302 and/or payee/device 304, respectively. The verification engine 310 may be configured to read the bank account handle certificates 316, 318. The bank account handle certificates 316, 318 may be provided in the generated request 301 and/or may be retrieved by the verification engine 310 by accessing the corresponding website of the bank account handle URL and reading the verification certificate contained in the website (as shown in FIG. 3c). The account information may be resolved simply by reading the content of the verification certificate/handle 316, 318. If both are valid, the verification engine may initiate the payment transaction, at 328. Otherwise, an error may be generated, which may prompt re-verification of the handles and/or rejection of the generated requested 301.

Using the handles 316, 318, the verification engine 310 may instruct device 306 (e.g., financial institution of the payer) to transmit payment to the device 308 (e.g., financial institution of the payee). To do so, the verification engine 310 may be configured to generate one or more transaction handles 312 and/or one or more transaction context blocks 314, at 330.

Once the transaction handles 312 and transaction context blocks 314 are generated, the verification engine 310 may be configured to transmit, at 332, to the device 306 a payment request 307 to initiate payment 309 to the device 308. The verification engine 310 may also receive a confirmation 311 from the device 306 that the payment has been sent and/or made. One or more application programming interfaces may be used between the verification engine 310, device 306 and/or device 308 to allow for transmission of requests, confirmations and/or payments. Using the payer's bank account handle, the verification engine 310 may be configured to identify a channel through which payment instructions may be received. These may be included in the parameters/policies extension field 122 (as shown in FIG. 1B). For example, device 306 may only accept payment instructions with P2D2 based API's. In some implementations, payment instructions, depending on parameters/policies defined in the extension field 122, may also be transmitted by payee's financial institution(s) (e.g., bank(s)), such as, for instance, when a direct debit transaction is used, it is the payee's financial institution that may be instructed. The parameters/policies extension field 122 may include all necessary information to allow the verification engine 310 to correctly instruct the device 306 when transmitting the payment and the technical means to use.

FIG. 3d illustrates an exemplary transaction handle 312, according to some implementations of the current subject matter. As stated above, the transaction handle 312 may be generated by the verification engine 310 upon receiving a request for payment. The transaction handle 312 may include one or more of the following fields: a certificate signature 342, a validity date 344, a subject 346, a public key of certificate 348, an issuer name 350, additional attributes 352, and one or more extensions 354. The extensions may also include data fields 356 retrieved from the generated payment request 301 as well other extension fields. In particular, the transaction handle 312 may be a combination of a transaction handle certificate URL, which represents a fully qualified domain name (FQDN), and the corresponding certificate (the transaction handle certificate). The FQDN may include a path that directly addresses a resource (e.g., on a cloud accessible storage, and/or any other storage) where the transaction information may be stored. The transaction handle URL may incorporate a domain of the verification engine 310 (e.g., GPOS domain) followed by a unique path to the transaction block (e.g., https://gpos.com/txid/jrjeed12131af). This may allow an account user an ability to directly retrieve the transaction related information directly from the verification engine 310 (e.g., using a server-less architecture). The signature 342 of the certificate 314 may be an encrypted digest of the certificate content that may be encrypted using a private key of the verification engine 310.

The data fields 356 retrieved from the request may include at least one of the following: payer's bank account handle URL, payee's bank account handle URL, payment amount, currency (e.g., any unit of value exchange), reference, “valid from” data, “valid to” data, signature of the payer, signature of the payee (which may be optional) and/or any other fields and/or any combination thereof.

Additionally, extension fields 354 may include one or more of the following data fields. They may include a status field (e.g., initialized, ongoing, completed, rejected, error) indicating the status of the transaction is. The state “ongoing” and “initialized” may correspond to intermediate states, whereas states “completed”, “rejected” and “error” may correspond to final states. Further, the fields 354 may include status details field that may provide detailed information, e.g., in case of an error the field may specify the error message/context. The fields 354 may also include transaction initialization time, transaction ongoing time, transaction rejected time, transaction final time, transaction error time, etc. that may correspond to timestamps of the status changes, e.g., transaction initialization time may be the time the transaction was initialized; transaction error time may be the time the transaction went into an error state, etc. Every status field may include its own status timestamp. Moreover, the extension fields 354 may include a field for a transaction context block reference that may point to a data store where additional details of a transaction are maintained (e.g., transaction context block(s) 314, as shown in FIG. 3a).

FIG. 3e illustrates an exemplary transaction context block 314, according to some implementations of the current subject matter. As shown in FIG. 3e, each transaction handle (e.g., handle 312a) may correspond to its transaction context block (e.g., block 314a). A transaction context block may be used to store various context information about the transaction, e.g., this may include data/information about: an order 362 (as received from the payer 302), invoice 364 (as generated from the payee 304), delivery notification, etc. It may be used by parties to exchange context information about the transaction.

In some exemplary implementations, only payer and payee may store context data into the transaction block 314. To prove authenticity, the payer may be required sign the data the payer 302 stores in the transaction block 314 using a private key of the payer's handle 316 (as shown in FIG. 3a). Similarly, the payee 304 may be required to sign the data the payee stores using a private key of the payee's handle 318. Alternatively, or in addition to, the data may be encrypted. In this case, the payer 302, for instance, may encrypt the data using a public key of the payee's handle 318, and the payee 304 may encrypt the stored data using a public key of the payer's handle 316.

FIG. 3f illustrates an exemplary alternate transaction handle 312, according to some implementations of the current subject matter. The transaction handle 312 may correspond to a per transaction status handle. In particular, the handle 312 shown in FIG. 3f may include at least one of the following fields: the fields 342-352 (as shown in FIG. 3d) as well as one or more extension fields 355. The extension fields 355 may include fields 356 from the payment request (discussed above with regard to FIG. 3d). Additionally, the fields 355 may include a status (e.g., initialized, ongoing, completed, rejected, error) indicating the current status of the transaction, one or more status details providing detailed information (e.g., in case of an error, the field may specify the error message/context), next state transaction URL field that may include a URL of the next handle in the chain (where the chain may start with a first state “initialized”), and one or more transaction context block reference (discussed above).

FIG. 3g illustrates an exemplary transaction status handle chain 370, according to some implementations of the current subject matter. The chain 370 may begin with a transaction handle corresponding to a status or state “initialized” 372. The next handle 374 may correspond to the state “completed”. Subsequent handle 376 may include state “rejected”, which may be followed by the handle 378 corresponding to the state “error”.

Referring back to FIGS. 3a-b, after the payment 309 is received by the device 308, the device 308 may transmit a confirmation 313 of the payment to the verification engine 310. In response, the verification engine 310 may change the status of the transaction to “completed”, at 334. The verification engine 310 may then be configured transmit a notification 315 to the device 302 and a notification 317 to device 304 indicating completion of the transaction.

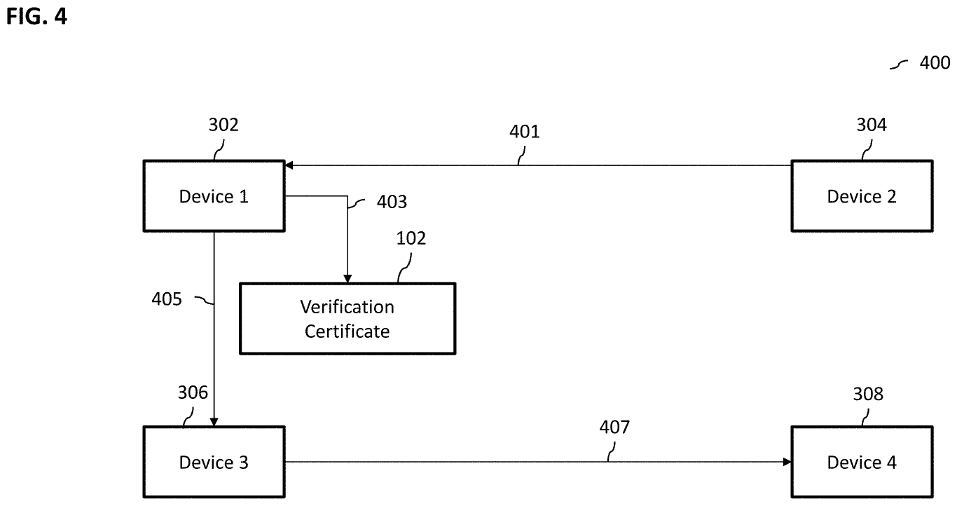

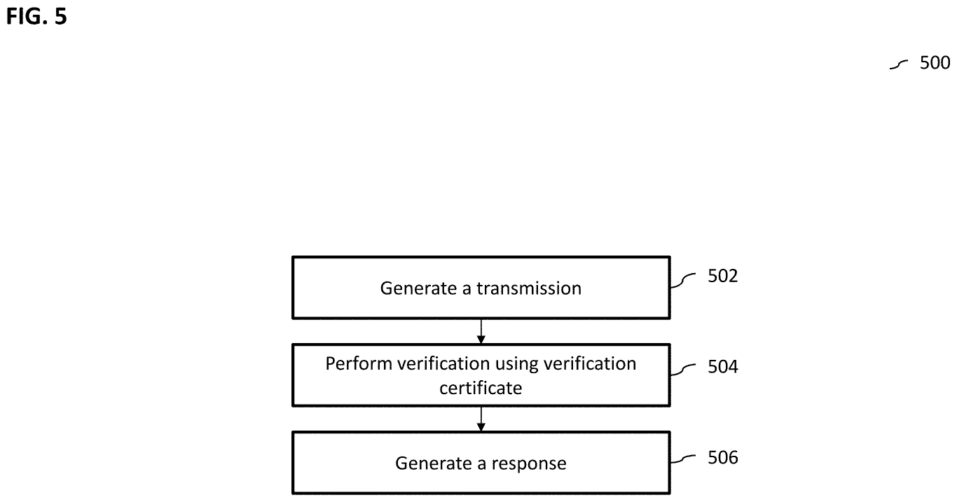

FIG. 4 illustrates an exemplary system 400 for performing a verification of data using a verification certificate, according to some implementations of the current subject matter. FIG. 5 illustrates an exemplary verification process 500 that may be executed by the system 400, according to some implementations of the current subject matter. The system 400 may include one or more computing components that may be similar to the computing components of the system 300 shown in FIG. 3a. The system 400 may be configured to provide access to the verification certificate 102 that may have been generated by the verification engine 310 (shown in FIG. 3a). Similar to system 300, the system 400 may be configured to operate in one or more cloud computing environments, clustered computing environments, and/or any other computing environments. It may include one or more users, entities, computing devices, servers, applications, etc. 302, 304, 306, and 308 (e.g., device 1 302, device 2 304, device 3 306, device 4 308, etc.) that may be configured to execute a secure exchange of data and/or any other secure transactions using the verification certificate 102. The devices 302-308 may include one or more computing elements and/or components, which may, for example, include one or more processors, one or more servers, one or more computing engines, one or more memory and/or storage locations, one or more databases, etc.

Referring to FIGS. 4-5, using the system 400, the device 304 may be configured to generate a transmission 401 that may relate to a particular transaction that the device 304 wishes to execute with device 302 (e.g., an invoice payment transaction) and send it to the device 302, at 502. The transmission 401 may be configured to include various details related to the transactions as well as an identification of a location where the verification certificate 102 may be accessed by the device 302. For example, the identification of the location may include a URL and/or any other identifier that may point to a web site containing the verification certificate 102. The website may be hosted by the verification engine 310 (shown in FIG. 3a) and/or any other third party.

Upon receipt of the transmission 401, the device 302 may be configured to access the verification certificate 102 using the URL/identifier provided by the device 304. Using the verification certificate, the device 30 may perform verification and/or authentication of the information contained in the transmission 401, at 504. The device 302 may read the verification certificate 102 to extract information contained in the verification certificate 102, and then, compare the information received in the transmission 401 with the information extracted from the verification certificate 102. If the information contained in the verification certificate 102 has been hashed, the device 302 may be configured to use a hashing algorithm that may be identified in the verification certificate 102 to hash the information received in the transmission 401, and compare a hash value of the information contained in the verification certificate 102 and the hash value generated as a result of hashing the information in the transmission 401. If hash values match (and/or match to a predetermined threshold level of confidence), then the device 302 may determine that the information contained in the transmission 401 has been verified and may generate a response to the device 302, at 506, such as, by proceeding with executing a transaction with the device 304. For example, the device 302 may instruct the device 306 to transmit certain information/data to device 308 that may be associated with device 304.

For example, the system 400 and process 500 may be used in verification of a payment transaction, as discussed in connection with the example above. In this case, the supplier (e.g., device 304) may be configured to transmit an invoice to the buyer (e.g., device 302) and request payment. The invoice may include various details (e.g., name and contact details of the supplier, the products purchased, tax details, bank account information of the supplier, etc.) as well as supplier's payment details resolution URL (e.g., www.account-supplier-A.com/account 1). The URL may point to a location where the verification certificate 102 that may be used to verify device 304's account information may be stored. In some exemplary implementations, the supplier may transmit the invoice electronically with the account verification certificate embedded.

In order to verify an authenticity of the transmitted invoice, the buyer (e.g., device 302) may access the verification certificate 102. The buyer may verify the suppliers account information automatically, manually, and/or in any other way. In the automatic authentication, buyer's accounting system, accounts payables automation system, any other computer program, etc. may be configured to verify the account information automatically. Such program may access the verification certificate using the provided URL and read the content of the verification certificate along with any extension fields (as discussed above). The buyer's program may then compare the account information in the verification certificate with the account information received together with the invoice.

If the account information is hashed, the buyer's program first determines the hashing algorithm from in the verification certificate (e.g., as declared in the verification certificate's extension fields), execute the hashing algorithm on the received account information and compares the generated hashed value of the received account information with the hash value contained in the verification certificate. If both hash values are equal, the buyer's program may be configured to return a “verified” status. Otherwise, the program may generate an error and reject the invoice.

Alternatively, or in addition to, the buyer's program may perform a manual authentication. In this case, the buyer may perform the authentication on a “self-service” basis. The buyer may access the website using the provided the URL. The website may include all information that the verification certificate may include in a readable manner and provide a verification process (e.g., similar to the one described above) if the account information is stored as a hash value.

Once the account information has been verified, the buyer may instruct (e.g., at 403) its bank (e.g., device 306) to transmit payment 407 to the supplier's bank (e.g., device 308).

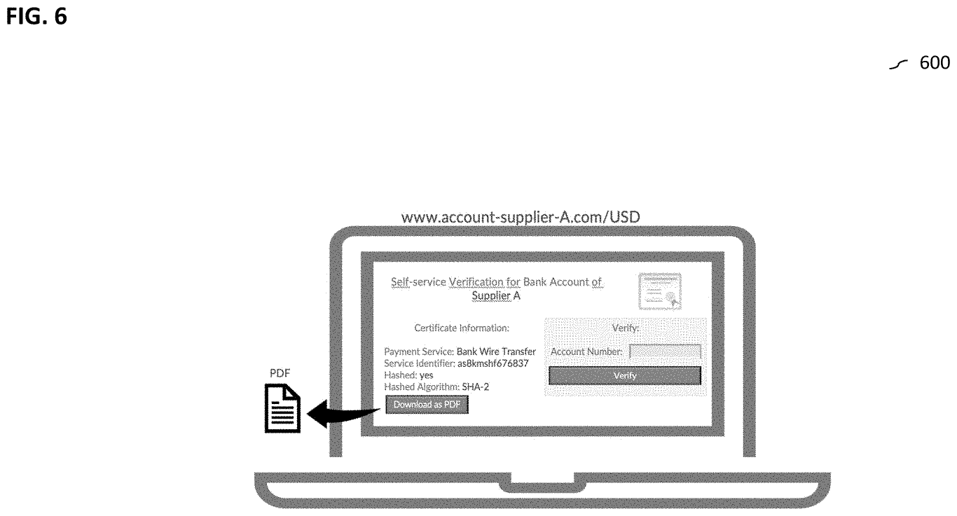

FIG. 6 illustrates an exemplary website 600 for verifying the account information that may be used by the system 400, according to some implementations of the current subject matter. The website 600 may be configured to include various “Certificate Information”, such as “Payment Service”, “Service Identifier”, “Hashed”, “Hashed Algorithm”, as well as provide an action button (e.g., “Verify”) to perform verification of the account information.

In some exemplary, non-limiting, implementations, the current subject matter may be configured to be used for performing a user account lookup (UAL). In this case, domain name and qualifiers may be served a distributed reverse proxy network running lambda functions. This may act as server-less architecture, providing inherent scaling, protection from DDoS attacks, and execution speed, whereby users are routed via DNS to their closest CDN edge. Account information may be stored in a cloud storage system, e.g., via a globally distributed key/value (KV) store. Keys may be derived from domain name qualifiers and values may correspond to the digitally signed account information. If a key does not exist as specified by the domain, then a redirect is performed to the web portal. Lambdas may also be securely protected and available for an application programming interface (API) to exclusively access the KV store. On a backend, an API may be used for customer access. It may provide authentication, admin services, e.g., bank information registration and updating. The API may be executed on a dedicated cloud-based infrastructure and may be served using RESTful JSON via HTTPS. A frontend of this system may implement existing web technologies and configured to interact with the API to provide a customer web portal via user interface (UI). The web portal may be executed on dedicated cloud-based infrastructure and may be served via HTTPS.

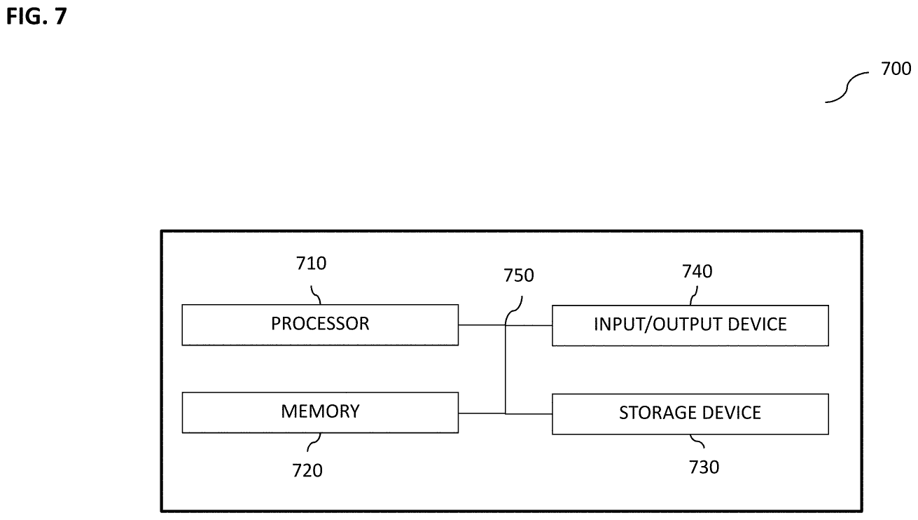

In some implementations, the current subject matter can be configured to be implemented in a system 700, as shown in FIG. 7. The system 700 can include a processor 710, a memory 720, a storage device 730, and an input/output device 740. Each of the components 710, 720, 730 and 740 can be interconnected using a system bus 750. The processor 710 can be configured to process instructions for execution within the system 700. In some implementations, the processor 710 can be a single-threaded processor. In alternate implementations, the processor 710 can be a multi-threaded processor. The processor 710 can be further configured to process instructions stored in the memory 720 or on the storage device 730, including receiving or sending information through the input/output device 740. The memory 720 can store information within the system 700. In some implementations, the memory 720 can be a computer-readable medium. In alternate implementations, the memory 720 can be a volatile memory unit. In yet some implementations, the memory 720 can be a non-volatile memory unit. The storage device 730 can be capable of providing mass storage for the system 700. In some implementations, the storage device 730 can be a computer-readable medium. In alternate implementations, the storage device 730 can be a floppy disk device, a hard disk device, an optical disk device, a tape device, non-volatile solid state memory, or any other type of storage device. The input/output device 740 can be configured to provide input/output operations for the system 700. In some implementations, the input/output device 740 can include a keyboard and/or pointing device. In alternate implementations, the input/output device 740 can include a display unit for displaying graphical user interfaces.

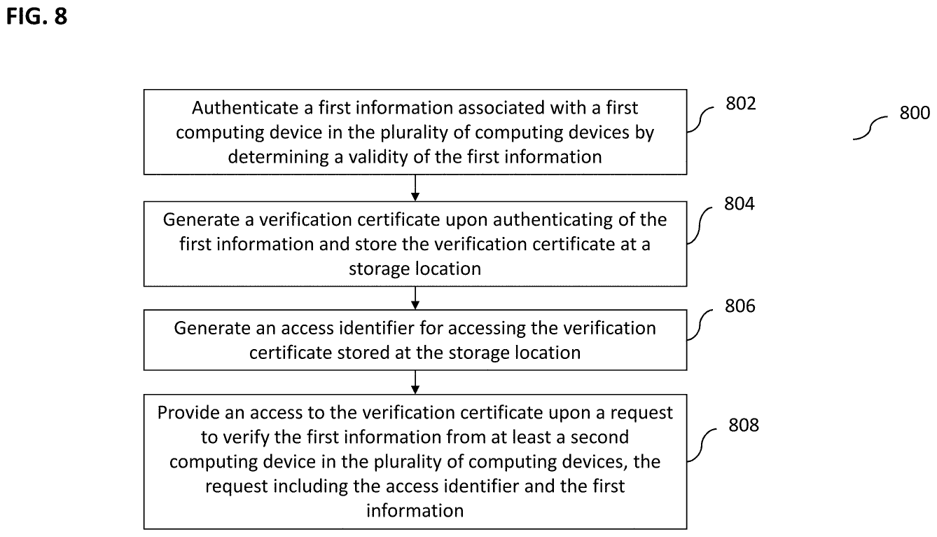

FIG. 8 illustrates an exemplary method 800 for executing a secure data exchange, according to some implementations of the current subject matter. The method 800 may be executed using one or more components of the system and discussed in connection with FIGS. 1a-7.

At 802, the verification engine 310 (as shown in FIG. 3a), for instance, may perform authentication and/or verification of a first information (e.g., account information) associated with a first computing device (e.g., device 304 (e.g., supplier)) in the plurality of computing devices. Authentication may include determining a validity of the first information. The authentication/verification of the account information associated with the device 304 may be performed in accordance with the discussion above related to FIGS. 1a-3g. Alternatively, or in addition, such authentication process may be referred to as registration, as stated above.

At 804, the verification engine 310 may be configured to generate a verification certificate (e.g., certificate 102) upon authenticating of the first information. An exemplary verification certificate 102 is illustrated in FIG. 1a. The verification certificate 102 may be stored at a storage location.

At 806, the verification engine may be configured to generate an access identifier for accessing the verification certificate stored at the storage location. The access identifier may be configured to include a URL, as discussed above. The URL may be transmitted to the device 302 and may be used by the device 302 to access the verification certificate to verify the information presented to it by the device 304, as shown in FIG. 4.

At 808, an access to the verification certificate may be provided upon a request to verify the first information from at least a second computing device (e.g., device 302) in the plurality of computing devices. The request may include the access identifier (e.g., URL) and the first information (which may be received from the device 304 and may, for example, include an invoice).

In some implementations, the current subject matter can include one or more of the following optional features. The access identifier may include a universal resource locator. In some implementations, the second computing device, using the universal resource locator, may be configured to access the verification certificate (e.g., as shown in FIG. 4). The verification certificate may be configured to be displayed on a website (e.g., website 600 shown in FIG. 6) associated with the universal resource locator.

In some implementations, the verification certificate may be configured to include the authenticated first information (e.g., bank account information that has been authenticated and/or verified using systems and processes shown in FIGS. 1a-3g). The verification certificate may be configured to include a first hashed value (e.g., in one of the extension fields 114 of the verification certificate 102 shown in FIG. 1B) of the authenticated first information. The first hashed value of the authenticated first information may be generated using a hashing algorithm identified in the verification certificate (e.g., in one of the extension fields 114 of the verification certificate 102 shown in FIG. 1B). The providing access may also include verification. Verification may include hashing the first information included in the received request (e.g., from entity 302) using the hashing algorithm identified in the verification certificate and generating a second hash value, and comparing the first hash value and the second hash value. Upon the first hash value matching the second hash value, the first information included in the received request may be verified. Upon the first hash value not matching the second hash value, verification of the first information included in the received request may be denied.

In some exemplary implementations, the first information may be associated with a payment transaction and the first hashed value in the verification certificate may correspond to a hashed value of an authenticated account information for executing the payment transaction.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

1. A computer-implemented method, comprising:
authenticating, using at least one processor, a first information associated with a first computing device in the plurality of computing devices, the authenticating including determining a validity of the first information;
generating, using the at least one processor, a verification certificate upon authenticating of the first information and storing the verification certificate at a storage location;
generating, using the at least one processor, an access identifier for accessing the verification certificate stored at the storage location; and
providing, using the at least one processor, an access to the verification certificate upon a request to verify the first information from at least a second computing device in the plurality of computing devices, the request including the access identifier and the first information.

2. The method according to claim 1, wherein the access identifier includes a universal resource locator.

3. The method according to claim 2, wherein the second computing device, using the universal resource locator, is configured to access the verification certificate, the verification certificate is configured to be displayed on a website associated with the universal resource locator.

4. The method according to claim 1, wherein the verification certificate is configured to include the authenticated first information.

5. The method according to claim 1, wherein the verification certificate is configured to include a first hashed value of the authenticated first information, the first hashed value of the authenticated first information being generated using a hashing algorithm identified in the verification certificate.

6. The method according to claim 1, wherein the providing further comprises
hashing the first information included in the received request using the hashing algorithm identified in the verification certificate and generating a second hash value; and
comparing the first hash value and the second hash value;
wherein
upon the first hash value matching the second hash value, verifying the first information included in the received request; and
upon the first hash value not matching the second hash value, denying verification of the first information included in the received request.

7. The method according to claim 1, wherein the first information is associated with a payment transaction and the first hashed value in the verification certificate corresponding to a hashed value of an authenticated account information for executing the payment transaction.

8. The method according to claim 7, further comprising generating a transaction certificate for the payment transaction.

9. The method according to claim 8, further comprising storing one or more statuses of the payment transaction in the transaction certificate.

10. The method according to claim 9, wherein each of the one or more statuses of the payment transaction corresponds to a transaction status certificate.

11. The method according to claim 7, further comprising storing at least a portion of data included in the verification certificate in the transaction certificate of the payment transaction.

12. The method according to claim 7, further comprising storing a pointer to at least another transaction in the transaction certificate of the payment transaction.

13. The method according to claim 1, wherein the verification certificate includes a digital certificate.

14. A system comprising:
at least one programmable processor; and
a machine-readable medium storing instructions that, when executed by the at least one programmable processor, cause the at least one programmable processor to perform operations comprising:
authenticating, using at least one processor, a first information associated with a first computing device in the plurality of computing devices, the authenticating including determining a validity of the first information;
generating, using the at least one processor, a verification certificate upon authenticating of the first information and storing the verification certificate at a storage location;
generating, using the at least one processor, an access identifier for accessing the verification certificate stored at the storage location; and
providing, using the at least one processor, an access to the verification certificate upon a request to verify the first information from at least a second computing device in the plurality of computing devices, the request including the access identifier and the first information.

15. The system according to claim 14, wherein the access identifier includes a universal resource locator.

16. The system according to claim 15, wherein the second computing device, using the universal resource locator, is configured to access the verification certificate, the verification certificate is configured to be displayed on a website associated with the universal resource locator.

17. The system according to claim 14, wherein the verification certificate is configured to include the authenticated first information.

18. The system according to claim 14, wherein the verification certificate is configured to include a first hashed value of the authenticated first information, the first hashed value of the authenticated first information being generated using a hashing algorithm identified in the verification certificate.

19. The system according to claim 14, wherein the providing further comprises
hashing the first information included in the received request using the hashing algorithm identified in the verification certificate and generating a second hash value; and
comparing the first hash value and the second hash value;
wherein
upon the first hash value matching the second hash value, verifying the first information included in the received request; and
upon the first hash value not matching the second hash value, denying verification of the first information included in the received request.

20. The system according to claim 14, wherein the first information is associated with a payment transaction and the first hashed value in the verification certificate corresponding to a hashed value of an authenticated account information for executing the payment transaction.

21. The system according to claim 20, wherein the operations further comprise generating a transaction certificate for the payment transaction.

22. The system according to claim 21, wherein the operations further comprise storing one or more statuses of the payment transaction in the transaction certificate.

23. The system according to claim 22, wherein each of the one or more statuses of the payment transaction corresponds to a transaction status certificate.

24. The system according to claim 20, wherein the operations further comprise storing at least a portion of data included in the verification certificate in the transaction certificate of the payment transaction.

25. The system according to claim 20, wherein the operations further comprise storing a pointer to at least another transaction in the transaction certificate of the payment transaction.

26. The system according to claim 14, wherein the verification certificate includes a digital certificate.

27. A computer program product comprising a machine-readable medium storing instructions that, when executed by at least one programmable processor, cause the at least one programmable processor to perform operations comprising:
authenticating, using at least one processor, a first information associated with a first computing device in the plurality of computing devices, the authenticating including determining a validity of the first information;
generating, using the at least one processor, a verification certificate upon authenticating of the first information and storing the verification certificate at a storage location;
generating, using the at least one processor, an access identifier for accessing the verification certificate stored at the storage location; and
providing, using the at least one processor, an access to the verification certificate upon a request to verify the first information from at least a second computing device in the plurality of computing devices, the request including the access identifier and the first information.

28-39. (canceled)
